(19) United States
(12) Patent Application Publication
(10) Pub. No.: US 2024/0300705 A1
(43) Pub. Date: Sep. 12, 2024

(54) CONTAINER COMPRISING FIBERS, COMPRISING A CONTAINER BODY COMPRISING FIBERS AND A HINGED CLOSURE COMPRISING FIBERS ARRANGED ON THE CONTAINER BODY, AND A HINGED CLOSURE COMPRISING FIBERS

(71) Applicant: Krones AG, Neutraubling (DE)

(72) Inventors: Konrad SENN, Alteglofsheim (DE); Jörg ZACHARIAS, Koefering (DE); Ulrich LAPPE, Neutraubling (DE)

(21) Appl. No.: 18/593,506

(22) Filed: Mar. 1, 2024

(30) Foreign Application Priority Data
Mar. 7, 2023 (DE) 102023105573.9

(51) Int. Cl. B65D 45/06; B65D 1/02; B65D 65/46

(52) U.S. Cl. CPC B65D 45/06; B65D 1/0207; B65D 1/023; B65D 65/466

(57) ABSTRACT

The disclosure relates to a container comprising fibers, comprising a container body comprising fibers and a hinged closure comprising fibers arranged on the container body. The container body comprises a neck region and a mouth opening. The hinged closure comprises a ring circumferentially surrounding the neck region and a closure body that, in a closed position of the hinged closure, closes the mouth opening. The ring and closure body are connected by two brackets. The disclosure further relates to the hinged closure comprising fibers.

### CROSS REFERENCE TO RELATED APPLICATION

The present application claims priority to German Patent Application No. 10 2023 105 573.9 filed on Mar. 7, 2023. The entire contents of the above-listed application are hereby incorporated by reference for all purposes.

### TECHNICAL FIELD

The disclosure relates to a container comprising fibers, comprising a container body comprising fibers and a hinged closure comprising fibers arranged on the container body, and to a hinged closure comprising fibers as described herein.

### BACKGROUND AND SUMMARY

It is known to equip containers comprising fibers with a plastic thread and plastic lids in order to be able to ensure reclosability of such a container. Reclosability of containers can be desirable in particular in the case of filling quantities of more than 200 mL, since this quantity is generally not emptied in one go. Due to the different materials, the container is not compostable and is also difficult to recycle.

The object of the disclosure is to provide a container comprising fibers, comprising a container body comprising fibers and a hinged closure comprising fibers arranged on the container body, and a hinged closure comprising fibers, which can allow a closability and optionally a reclosability of a container comprising fibers without providing a thread.

The object is achieved by the container comprising fibers, comprising a container body comprising fibers and a hinged closure comprising fibers arranged on the container body, and the hinged closure comprising fibers as described herein.

The container according to the disclosure comprising fibers comprises a container body comprising fibers and a hinged closure comprising fibers arranged on the container body. The container body comprises a neck region and a mouth opening. The hinged closure comprises a ring circumferentially surrounding the neck region and a closure body that is designed, in a closed position of the hinged closure, to close the mouth opening. The ring and the closure body are connected by two brackets.

Since the container body and the hinged closure comprise fibers, the container can be compostable and/or biodegradable.

The contour of the container body can be designed comparatively simply, because the provision of a thread, e.g., for screwing on and unscrewing a lid, is not necessary.

To attach the hinged closure to the container body, it may be sufficient to provide a sufficiently stable neck region.

The ring can rest flat on the neck region of the container body, which means that forces acting upon the neck region can be better and more evenly distributed.

The fibers may comprise lignin, banana leaves, and/or wild quinine. The fibers may, for example, comprise cellulose fibers, fibers of conifers, of leafy woody plants and/or plane trees and/or grasses, reeds and/or bamboo or the like. The fibers may comprise silk threads, spider silk, algae, natural fibers (such as Danube silphie fibers, hemp, maize, cotton), banana peel, orange peel, grass, straw, potato starch, or processed cow dung. It is also possible to provide cellulose fibers which originate from a process by which they were artificially grown. In the event of material bottlenecks, these alternative materials can completely or partially replace wood as the base material for a fluid mass with fibers.

The fibers can comprise fiber mixtures made of non-wood material, for example cotton, hemp, and/or textile fibers.

For example, the fibers may comprise viscose fibers. A viscose fiber is an artificial fiber made of regenerated cellulose, wherein the viscose fibers have, as starting base, 100% cellulose treated in a multi-stage process. The viscose fibers may comprise a flat or cable-shaped structure, a trilobal shape, or a double trilobal structure. The fibers may comprise a flat or hollow structure or a corrugated or rough outer surface.

Various types of fibers may also be used in combination. For example, fibers with different outer surfaces and/or shapes and/or hollow structure and/or flat structure and/or of different materials may be combined.

Due to the natural origin of the fibers, they may be biodegradable. In addition, they are sustainable and renewable.

The fibers may be used in a pulp. The pulp may be or comprise a mixture of water, e.g., with additives, and fibers.

The container body may be a bottle.

The molding of the container body comprising fibers using the fiber-containing pulp can take place in a mold that can represent a negative form of an outer contour of the one-piece container body to be produced, or by means of an injection-molding method.

A first fiber-containing pulp can be used to form the container body comprising fibers. A second fiber-containing pulp can be used to form the ring. A third fiber-containing pulp can be used to form the closure body. A fourth fiber-containing pulp can be used to form the two brackets.

The first, second, third, and fourth fiber-containing pulps can all be different, or two or three or all fiber-containing pulps can be the same.

The ring can have a width of 3 millimeters to 12 millimeters. The wider the ring, the better and more evenly forces can be distributed to the neck region.

The ring can have a thickness of 0.1 millimeters to 4 millimeters. The thickness can, for example, depend upon the material of the ring.

The ring can comprise a fiber-containing braid.

The ring can comprise cardboard and/or a fiber-containing cord, such as hemp cord.

The ring can comprise a biodegradable and/or recyclable material.

A seal can be arranged on the closure body, and can come to lie in the closed position between the closure body and the mouth opening. For example, the seal can comprise a biologically degradable and/or recyclable material. For example, the biodegradable material can comprise rubber and/or polyhydroxyalkanoates (PHA). For example, the seal can comprise silicone rubber or silicone. For example, the seal can be arranged so as to be fixed, but mechanically releasable, on the closure body.

For example, the seal can be removed from the closure body when the container is sent to a recycling stream.

A first connecting region of the bracket and the ring can allow a first relative movement from the bracket to the ring. The first relative movement can make it possible to move the hinged closure from an open position to a closed position or vice versa without damaging the hinged closure.

A second connecting region of the bracket and the closure body can allow a second relative movement between the bracket and the closure body. The second relative movement can make it possible to move the hinged closure from an open position to a closed position or vice versa without damaging the hinged closure.

The bracket can comprise a fiber-containing braid. The bracket can comprise cardboard and/or a fiber-containing cord, such as hemp cord. The bracket can comprise a biodegradable and/or recyclable material.

For example, in the case of a hinged closure, the bracket and the ring can comprise the same material. Alternatively, in the case of a hinged closure, the bracket and the ring can comprise different materials.

The bracket can be designed to be rigid, wherein, for example, the first connecting region and/or the second connecting region can be designed as a cotter pin or can comprise a movement groove. In this case, “rigid” can mean that the bracket can be designed in one piece. By providing a cotter pin or a movement groove, it can be achieved that the closure body can be placed on the mouth opening (closed position) or removed therefrom (open position), although, in the closed position, the container body can still be closed in such a way that, for example, no product can leak out of the container body.

Alternatively, the bracket can be designed in two parts with a joint between a first bracket part and a second bracket part. By providing the joint between the two bracket parts, the closure body can be placed on the mouth opening (closed position) or removed therefrom (open position), because the first and second bracket parts can move against each other. In the closed position, the container body can be closed, so that, for example, no product can leak out of the container body.

The hinged closure can also comprise a movement-limiting guide for the bracket. For example, the guide can be arranged on the neck region or on a shoulder region of the container body comprising fibers. The movement-limiting guide can, for example, limit the movement of the bracket or a bracket part in the closed position so that a secure fit of the closure body on the mouth opening can be achieved in the closed position.

Each of the brackets can additionally comprise a pulling device, which can be designed to disconnect at least one of the brackets from the closure body when a pulling force is exerted when the hinged closure is arranged in a closed position, e.g., in the second connecting region, so that the mouth opening can be released. If only one of the brackets is separated from the closure body, the other bracket can remain connected to the closure body after being moved to the open position.

The neck region can comprise at least one rim. For example, a first rim can be at least partially in contact with the seal of the closure body in a closed position of the hinged closure. For example, the first and/or a second rim can be provided to limit the movement of the ring.

The rim can provide sufficient stability to the neck region of the container body. In the closed position, the rim can be used at least partially as a counterpart to the closure body, wherein the seal comes to lie at least partially between the rim and the closure body.

The rim can have a rectangular, triangular, pentagonal, or hexagonal cross-section, wherein, for example, one or more edges can be rounded. The rim can have a round cross-section.

In addition, a hinged closure comprising fibers is provided, which can be arranged on a container body comprising fibers. The hinged closure comprises a ring that is designed to circumferentially surround a neck region of a container body, and a closure body. The ring and the closure body are connected by two brackets.

The ring can have a width of 3 millimeters to 12 millimeters.

The ring can have a thickness of 0.1 millimeters to 4 millimeters.

The ring can comprise a fiber-containing braid.

The ring can comprise cardboard and/or a fiber-containing cord, such as hemp cord.

The ring can comprise a biodegradable and/or recyclable material.

A seal can be arranged on the closure body. For example, the seal can comprise a biodegradable and/or recyclable material, such as rubber and/or polyhydroxyalkanoates (PHA). The seal can comprise, for example, silicone rubber or silicone. For example, the seal can be arranged so as to be fixed, but mechanically releasable, on the closure body.

A first connecting region of the bracket and the ring can allow a first relative movement from the bracket to the ring.

A second connecting region of the bracket and the closure body can allow a second relative movement between the bracket and the closure body.

The bracket can comprise a fiber-containing braid. The bracket can comprise cardboard and/or a fiber-containing cord, such as hemp cord. The bracket can comprise a biodegradable and/or recyclable material.

For example, in the case of a hinged closure, the bracket and the ring can comprise the same material. Alternatively, in the case of a hinged closure, the bracket and the ring can comprise different materials.

The hinged closure can further comprise a movement-limiting guide for the bracket, wherein, for example, the guide can be arranged on the neck region or on a shoulder region of the container body comprising fibers.

The bracket can be designed to be rigid, wherein, for example, the first connecting region and/or the second connecting region can be designed as a cotter pin or can comprise a movement groove.

Alternatively, the bracket can be designed in two parts with a joint between a first bracket part and a second bracket part.

### BRIEF DESCRIPTION OF FIGURES

The accompanying figures show, by way of example, aspects and/or exemplary embodiments of the disclosure for better understanding and illustration. In the figures:

FIG. 1A shows a first embodiment of a container comprising fibers with a container body comprising fibers and with a hinged closure comprising fibers, which is in an open position,

FIG. 1B shows the first embodiment, wherein the hinged closure is in the closed position,

FIG. 2A shows a second embodiment of a container comprising fibers with a container body comprising fibers and with a hinged closure comprising fibers, which is in an open position,

FIG. 2B shows a third embodiment of a container comprising fibers with a container body comprising fibers and with a hinged closure comprising fibers, which is in the closed position,

FIG. 2C shows a fourth embodiment of a container comprising fibers with a container body comprising fibers and with a hinged closure comprising fibers, which is in the closed position,

FIG. 3A shows a fifth embodiment of a container comprising fibers with a container body comprising fibers and with a hinged closure comprising fibers, which in the closed position,

FIG. 3B shows the fifth embodiment, wherein the hinged closure is in the open position,

FIG. 3C shows a sixth embodiment of a container comprising fibers with a container body comprising fibers and with a hinged closure comprising fibers, which is in the open position,

FIG. 4A shows a first embodiment of the ring,

FIG. 4B shows a second embodiment of the ring,

FIG. 4C shows a third embodiment of the ring,

FIG. 5A shows a first embodiment of a rim,

FIG. 5B shows a second embodiment of a rim,

FIG. 5C shows a third embodiment of a rim,

FIG. 5D shows a fourth embodiment of a rim,

FIG. 5E shows a fifth embodiment of a rim,

FIG. 6A shows a sixth embodiment of a rim,

FIG. 6B shows a seventh embodiment of a rim,

FIG. 6C shows a eighth embodiment of a rim, and

FIG. 6D shows a ninth embodiment of a rim.

### DETAILED DESCRIPTION OF FIGURES

With regard to the fibers of the container, the container body, and/or the hinged closure mentioned below, that which has already been explained above may apply.

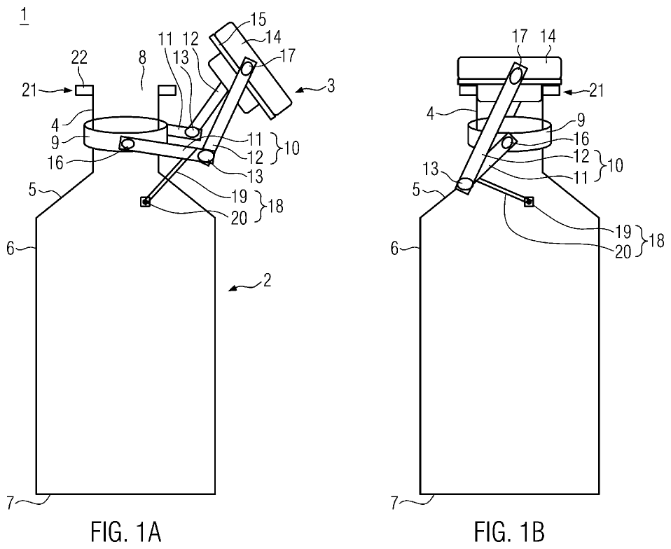

FIG. 1A shows a first embodiment of a container 1 comprising fibers with a container body 2 comprising fibers and with a hinged closure 3 comprising fibers, which is in an open position. The container body 2 comprises a neck region 4, a shoulder region 5, a body region 6, and a bottom region 7. A mouth opening 8 is provided adjacent to the neck region 4.

The hinged closure 3 comprises a ring 9 circumferentially surrounding the neck region 4, two brackets 10, each of which comprises a first bracket part 11 and a second bracket part 12, and a closure body 14 having a seal 15. A first connecting region 16 from the first bracket part 11 and the ring 9 allows a first relative movement from the first bracket part 11 to the ring 9. The first bracket part 11 and the second bracket part 12 are movably connected to one another by means of a joint 13. A second connecting region 17 of the second bracket part 12 and the closure body 14 allows a second relative movement between the second bracket part 12 and the closure body 14.

The first connecting region 16 of the one first bracket part 11 having the ring 9 and the first connecting region 16 of the other first bracket part 11 having the ring 9 are arranged at diametrically opposite positions of the ring 9.

The second connecting region 17 of the one second bracket part 12 having the closure body 14 and the second connecting region 17 of the other second bracket part 12 having the closure body 14 are in this case arranged at diametrically opposite positions of the closure body 14.

The hinged closure 3 also comprises a movement-limiting guide 18 for each of the brackets 10. The movement-limiting guide 18 comprises a fastener 20, which is arranged on the shoulder region 5 of the container body 2, and a guide means 19, such as a band or, which extends from the fastener 20 around the first bracket part 11 and is movably arranged on the first bracket part 11. The movement-limiting guide 18 is intended to limit the movement of the first bracket part 11 (and thus of the bracket 10 itself) when the hinged closure 3 is arranged in a closed position.

In addition, the container body 2 comprises a rim 21, on the upper surface 22 of which, in the closed position of the hinged closure 3, the seal 15 can rest at least partially and provide a seal. The upper surface 22 of the rim 21 in this case terminates with the mouth opening 8 of the container body 2.

FIG. 1B shows the first embodiment, wherein the hinged closure 3 is in the closed position. The mouth opening 8 is closed by the closure body 14 and sealed by the seal 15, which rests at least partially on the upper surface 22 of the rim 21.

In the closed position of the hinged closure 3, the movement-limiting guide 18 ensures that the movement of the first bracket part 11 is limited and that it cannot move further to the left, which could result in the hinged closure 3 being able to reach an open position from the closed position and thus the container body 2 no longer being reliably closed.

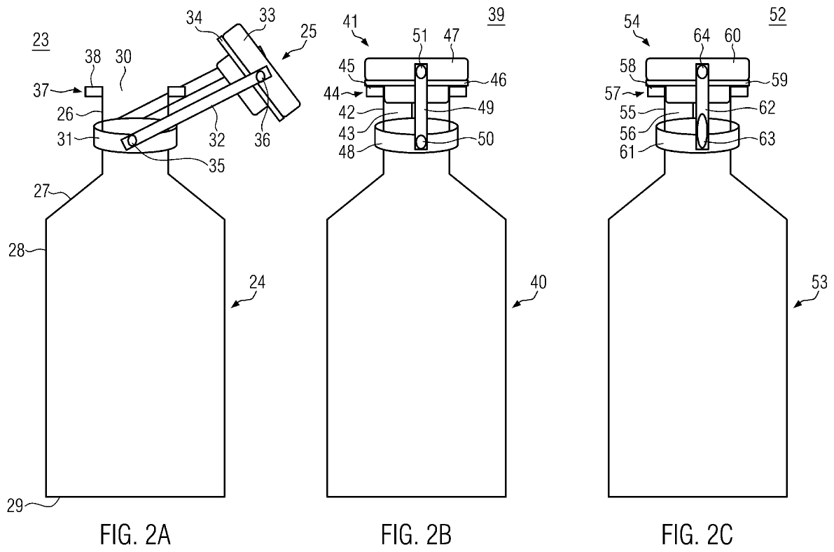

FIG. 2A shows a second embodiment of a container 23 comprising fibers with a container body 24 comprising fibers and with a hinged closure 25 comprising fibers, which is in an open position.

The container body 24 comprises a neck region 26, a shoulder region 27, a body region 28, and a bottom region 29. A mouth opening 30 is provided adjacent to the neck region 26.

The hinged closure 25 comprises a ring 31 circumferentially surrounding the neck region 26, two brackets 32, and a closure body 33 having a seal 34. A first connecting region 35 of the bracket 32 and the ring 31 allows a first relative movement from the bracket 32 to the ring 31. A second connecting region 36 of the bracket 32 and the closure body 33 allows a second relative movement between the bracket 32 and the closure body 33.

The first connecting region 35 of the one bracket 32 having the ring 31 and the first connecting region 35 of the other bracket 32 having the ring 31 are arranged at diametrically opposite positions of the ring 31.

The second connecting region 36 of the one bracket 32 having the closure body 33 and the second connecting region 36 of the other bracket 32 having the closure body 33 are in this case arranged at diametrically opposite positions of the closure body 33.

In addition, the container body 24 comprises a rim 37, on the upper surface 38 of which, in the closed position of the hinged closure 25, the seal 34 can rest at least partially and provide a seal. The upper surface 38 of the rim 37 in this case terminates with the mouth opening 30 of the container body 24.

FIG. 2B shows a third embodiment of a container 39 comprising fibers with a container body 40 comprising fibers and with a hinged closure 41 comprising fibers, which is in the closed position.

The container body 40 comprises, among other things, a neck region 42 and a mouth opening 43 arranged adjacent to the neck region 42. In addition, the container body 40 comprises a rim 44 having an upper surface 45 on which, in the closed position of the hinged closure 41, a seal 46 of a closure body 47 rests at least partially and ensures that the container body 40 is sealed. The upper surface 45 of the rim 44 in this case terminates with the mouth opening 43 of the container body 40.

In addition to the closure body 47 having the seal 47, the hinged closure 41 comprises a ring 48, which circumferentially surrounds the neck region 42, and two brackets 49. A first connecting region 50 of the bracket 49 and the ring 48 allows a first relative movement from the bracket 43 to the ring 48. In this case, the first connecting region 50 is provided as a cotter pin. A second connecting region 51 of the bracket 49 and the closure body 47 allows a second relative movement between the bracket 49 and the closure body 47.

The first connecting region 50 of the one bracket 49 having the ring 48 and the first connecting region 50 of the other bracket 49 having the ring 48 are arranged at diametrically opposite positions of the ring 48.

The second connecting region 51 of the one bracket 49 having the closure body 47 and the second connecting region 51 of the other bracket 49 having the closure body 47 are in this case arranged at diametrically opposite positions of the closure body 47.

In the closed position shown, the closure body 47 closes the mouth opening 43, and the seal 46 seals the container body 40.

FIG. 2C shows a fourth embodiment of a container 52 comprising fibers with a container body 53 comprising fibers and with a hinged closure 54 comprising fibers, which is in the closed position.

The container body 53 comprises, among other things, a neck region 55 and a mouth opening 56 arranged adjacent to the neck region 55. In addition, the container body 53 comprises a rim 57 having an upper surface 58 on which, in the closed position of the hinged closure 54, a seal 59 of a closure body 60 rests at least partially and ensures that the container body 53 is sealed. The upper surface 58 of the rim 57 in this case terminates with the mouth opening 56 of the container body 53.

In addition to the closure body 60 having the seal 59, the hinged closure 54 comprises a ring 61, which circumferentially surrounds the neck region 55, and two brackets 62. A first connecting region 63 of the bracket 62 and the ring 61 allows a first relative movement from the bracket 62 to the ring 61. In this case, the first connecting region 63 is provided as a groove. A second connecting region 64 of the bracket 62 and the closure body 60 allows a second relative movement between the bracket 62 and the closure body 60.

The first connecting region 63 of the one bracket 62 having the ring 61 and the first connecting region 63 of the other bracket 62 having the ring 61 are arranged at diametrically opposite positions of the ring 61.

The second connecting region 64 of the one bracket 62 having the closure body 60 and the second connecting region 64 of the other bracket 62 having the closure body 60 are in this case arranged at diametrically opposite positions of the closure body 60.

In the closed position shown, the closure body 60 closes the mouth opening 56, and the seal 59 seals the container body 53.

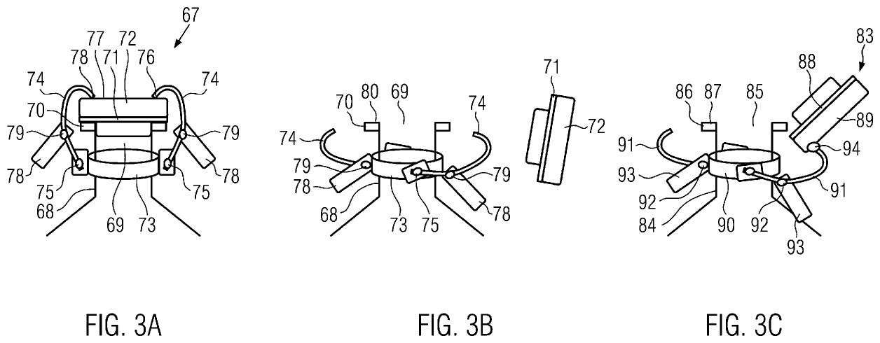

FIG. 3A shows a fifth embodiment of a container 65 comprising fibers with a container body 66 comprising fibers and with a hinged closure 67 comprising fibers, which is in the closed position.

The container body 66 comprises, among other things, a neck region 68 and a mouth opening 69 arranged adjacent to the neck region 68. In addition, the container body 66 comprises a rim 70 having an upper surface on which, in the closed position shown, a seal 71 of a closure body 72 rests at least partially and ensures that the container body 66 is sealed.

In addition to the closure body 72 having the seal 71, the hinged closure 67 comprises a ring 73, which circumferentially surrounds the neck region 68, and two brackets 74. A first connecting region 75 of the bracket 74 and the ring 73 allows a first relative movement from the bracket 74 to the ring 73. The bracket 74 and the closure body 72 are connected in a second connecting region 76.

The first connecting region 75 of the one bracket 74 having the ring 73 and the first connecting region 75 of the other bracket 74 having the ring 73 are arranged at diametrically opposite positions of the ring 73.

The second connecting region 76 of each bracket 74 is arranged on an upper surface 77 of the closure body 72.

Each of the brackets 74 also comprises a pulling device 78, which is designed to disconnect the brackets 74 from the closure body 72 when a pulling force is exerted when the hinged closure 67 is arranged in a closed position, so that the mouth 69 can be released (and the hinged closure 67 is in an open position). The pulling device 78 is connected to the bracket 74 by a third connecting region 79.

In the closed position shown, the closure body 72 closes the mouth opening 69, and the seal 71 seals the container body 66.

FIG. 3B shows the fifth embodiment, wherein the hinged closure 67 is in the open position. In order to reach the open position, the two brackets 74 were separated from the closure body 72 by applying a tensile force to the corresponding pulling device 78 when the hinged closure 67 was in the closed position, allowing the closure body 72 to be removed together with the seal 71 and the mouth 69 to be released. The upper surface 80 of the rim 70 can now also be seen. The upper surface 80 of the rim 70 in this case terminates with the mouth opening 69 of the container body 66.

FIG. 3C shows a sixth embodiment of a container 81 comprising fibers with a container body 82 comprising fibers and with a hinged closure 83 comprising fibers, which is in the open position.

The container body 82 comprises, among other things, a neck region 84 and a mouth opening 85 arranged adjacent to the neck region 84. In addition, the container body 82 comprises a rim 86 having an upper surface 87 on which, in a closed position, a seal 88 of a closure body 89 can rest at least partially and ensure that the container body 82 is sealed.

In addition to the closure body 89 having the seal 88, the hinged closure 83 comprises a ring 90, which circumferentially surrounds the neck region 84, and two brackets 91. A first connecting region 92 of the bracket 91 and the ring 90 allows a first relative movement from the bracket 91 to the ring 90. The first connecting region 92 of the one bracket 91 having the ring 90 and the first connecting region 92 of the other bracket 91 having the ring 90 are arranged at diametrically opposite positions of the ring 90.

Each of the brackets 91 also comprises a pulling device 93, which is designed to separate one of the brackets 91 from the closure body 89 when a pulling force is exerted when the hinged closure 83 is arranged in a closed position, so that the mouth opening 85 can be released, and the hinged closure 83 is in the open position shown. The other of the two brackets 91 remains connected to the closure body 89 in a second connecting region 94. The pulling device 93 is connected to the bracket 91 by a third connecting region 95.

FIG. 4A shows a first embodiment of the ring 96. The ring 96 circumferentially surrounds a neck region 97 of a container body 98 comprising fibers. The ring 96 has a first width b1. A movement of the ring 96 in a direction R1 upwards parallel to a longitudinal axis of the container body 98 can be prevented by a rim 100 of the container body 98. An upper surface of the rim 100 in this case terminates with the mouth opening 99 of the container body 98.

FIG. 4B shows a second embodiment of the ring 101. The ring 101 circumferentially surrounds a neck region 102 of a container body 103 comprising fibers. The ring 101 has a first width b2. A movement of the ring 101 in a direction R1 upwards parallel to a longitudinal axis of the container body 103 can be prevented by a rim 105 of the container body 103. An upper surface of the rim 105 in this case terminates with the mouth opening 104 of the container body 103.

FIG. 4C shows a third embodiment of the ring 106. The ring 106 circumferentially surrounds a neck region 107 of a container body 108 comprising fibers. The ring 106 has a first width b3. A movement of the ring 106 in a direction R1 upwards parallel to a longitudinal axis of the container body 108 can be prevented by a rim 110 of the container body 108. An upper surface of the rim 110 in this case terminates with the mouth opening 109 of the container body 108. The ring 106 comprises a first sub-region 111 and a second sub-region 112, wherein the first sub-region 111 can, for example, be made of a stronger material than the second sub-region 112.

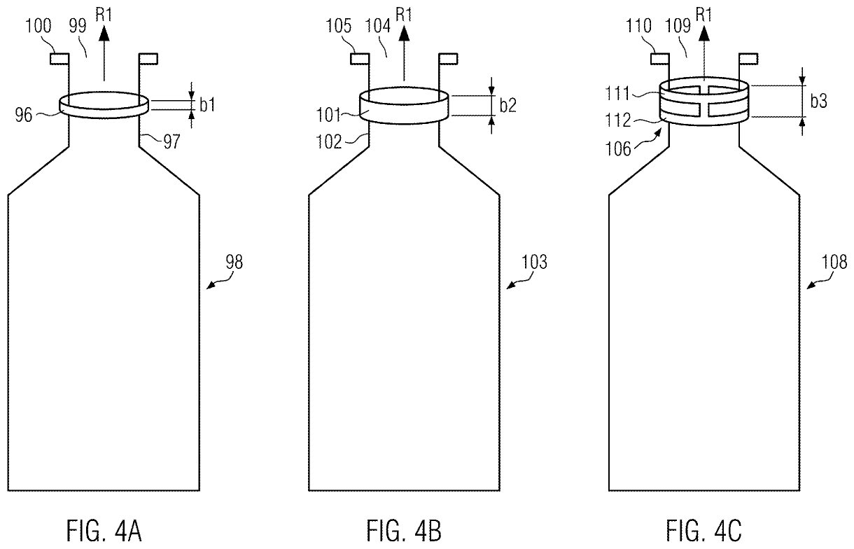

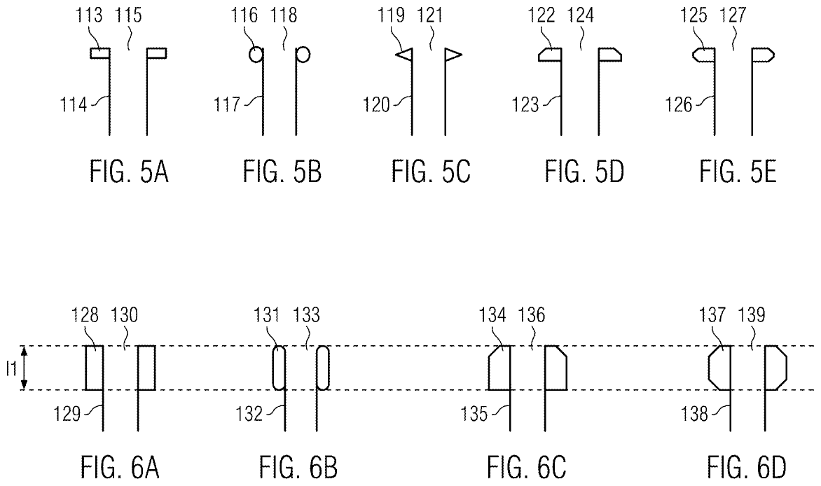

FIG. 5A shows a first embodiment of a rim 113, which is provided on a container body comprising fibers and which is provided at least partially circumferentially on a neck region 114. The rim 113 is provided so as to protrude radially and has a rectangular cross-section. An upper surface of the rim 113 in this case terminates with a mouth opening 115 of the container body.

FIG. 5B shows a second embodiment of a rim 116, which is provided on a container body comprising fibers and which is provided at least partially circumferentially on a neck region 117 of the container body. The rim 116 is provided so as to protrude radially and has a round cross-section. An upper edge of the rim 116 in this case terminates with a mouth opening 118 of the container body. An upper edge can be understood here as a circular ring, which can be provided by the uppermost rounded portion of the rim 116.

For example, the round cross-section of the rim can extend at least partially into the neck region 117 so that the cross-section of the rim that starts on the outer side of the mouth region can correspond to a circular segment (also referred to as a circular portion) with a height that can be greater than a radius of the circle. The height can correspond to 1.5 times to 1.8 times the radius. The limits of the range may be included. The height cannot be greater than twice the radius.

FIG. 5C shows a third embodiment of a rim 119, which is provided on a container body comprising fibers and which is provided at least partially circumferentially on a neck region 120 of the container body. The rim 119 is provided so as to protrude radially and has a triangular cross-section. An upper edge of the rim 119 in this case terminates with a mouth opening 121 of the container body.

FIG. 5D shows a fourth embodiment of a rim 122, which is provided on a container body comprising fibers and which is provided at least partially circumferentially on a neck region 123 of the container body. The rim 122 is provided so as to protrude radially. The rim 122 has a pentagonal cross-section, which corresponds to a rectangle with a cut-off corner facing away from the container body. An upper surface of the rim 122 in this case terminates with a mouth opening 124 of the container.

FIG. 5E shows a fifth embodiment of a rim 125, which is provided on a container body comprising fibers and which is provided at least partially circumferentially on a neck region 126 of the container body. The rim 125 is provided so as to protrude radially and has a hexagonal cross-section, which corresponds to a rectangle with two cut-off corners facing away from the container body. An upper surface of the rim 125 in this case terminates with a mouth opening 127 of the container.

FIG. 6A shows a sixth embodiment of a rim 128, which is provided on a container body comprising fibers and which is provided at least partially circumferentially on a neck region 129 of the container body. The rim 128 extends over a length l1 parallel to a longitudinal axis of the container body. Because of this expansion of the rim 128, the neck region 129 can, for example, have greater stability than a part of the neck region 129 in which no rim is provided. The rim 128 is provided so as to protrude radially and has an elongated, rectangular cross-section. An upper surface of the rim 128 in this case terminates with a mouth opening 130 of the container.

FIG. 6B shows a seventh embodiment of a rim 131, which is provided on a container body comprising fibers and which is provided at least partially circumferentially on a neck region 132 of the container body. The rim 131 extends over a length l1 parallel to a longitudinal axis of the container body. Because of this expansion of the rim 131, the neck region 132 can, for example, have greater stability than a part of the neck region 132 in which no rim is provided. The rim 131 is provided so as to protrude radially and has a triangular cross-section with rounded edges. An upper edge of the rim 131 in this case terminates with a mouth opening 133 of the container body. An upper edge can be understood here as a circular ring, which can be provided by the uppermost rounded portion of the rim 131.

FIG. 6C shows an eighth embodiment of a rim 134, which is provided on a container body comprising fibers and which is provided at least partially circumferentially on a neck region 135 of the container body. The rim 134 extends over a length l1 parallel to a longitudinal axis of the container body. Because of this expansion of the rim 134, the neck region 135 can, for example, have greater stability than a part of the neck region 135 in which no rim is provided. The rim 134 is provided so as to protrude radially. The rim 134 has a pentagonal cross-section, which corresponds to a rectangle with a cut-off corner facing away from the container body. An upper surface of the rim 134 in this case terminates with a mouth opening 136 of the container.

FIG. 6D shows a ninth embodiment of a rim 137, which is provided on a container body comprising fibers and which is provided at least partially circumferentially on a neck region 138 of the container body. The rim 137 extends over a length l1 parallel to a longitudinal axis of the container body. Because of this expansion of the rim 137, the neck region 138 can, for example, have greater stability than a part of the neck region 138 in which no rim is provided. The rim 137 is provided so as to protrude radially and has a hexagonal cross-section, which corresponds to a rectangle with two cut-off corners facing away from the container body. An upper surface of the rim 137 in this case terminates with a mouth opening 139 of the container body.

1. Container comprising fibers, comprising a container body comprising fibers and a hinged closure comprising fibers arranged on the container body,
wherein the container body comprises a neck region and a mouth opening,
wherein the hinged closure comprises a ring circumferentially surrounding the neck region and a closure body that is designed, in a closed position of the hinged closure, to close the mouth opening, wherein the ring and the closure body are connected by two brackets.

2. Container comprising fibers according to claim 1, wherein the ring has a width of 3 millimeters to 12 millimeters.

3. Container comprising fibers according to claim 1, wherein the ring has a thickness of 0.1 millimeters to 4 millimeters.

4. Container comprising fibers according to claim 1, wherein the ring comprises a fiber-containing braid.

5. Container comprising fibers according to claim 1, wherein the ring comprises cardboard and/or a fiber-containing cord.

6. Container comprising fibers according to claim 1, wherein a seal is arranged on the closure body, which seal comes to lie in the closed position between the closure body and the mouth opening.

7. Container comprising fibers according to claim 1, wherein a first connecting region of the bracket and the ring allows a first relative movement from the bracket to the ring.

8. Container comprising fibers according to claim 7, wherein a second connecting region of the bracket and the closure body allows a second relative movement between the bracket and the closure body.

9. Container comprising fibers according to claim 8, wherein the bracket is rigid, wherein, the first connecting region and/or the second connecting region is designed as a cotter pin or comprises a movement groove.

10. Container comprising fibers according to claim 7, wherein the bracket is formed in two parts with a joint between a first bracket part and a second bracket part.

11. Container comprising fibers according to claim 10, wherein the hinged closure further comprises a movement-limiting guide for the bracket, wherein the guide is arranged on the neck region or on a shoulder region of the container body comprising fibers.

12. Container comprising fibers according to claim 1, wherein each of the brackets additionally comprises a pulling device designed to disconnect at least one of the brackets from the closure body when a pulling force is exerted when the hinged closure is arranged in a closed position so that the mouth opening can be released.

13. Container comprising fibers according to claim 6, wherein the neck region comprises at least one rim, wherein, a first rim in a closed position of the hinged closure is at least partially in contact with the seal of the closure body, wherein, the first and/or a second rim are provided as a movement limitation for the ring.

14. Hinged closure, comprising fibers, that can be arranged on a container body comprising fibers, wherein the hinged closure comprises:
a ring, which is designed to circumferentially surround a neck region of a container body,
a closure body,
wherein the ring and the closure body are connected by two brackets.

15. Hinged closure comprising fibers according to claim 14, wherein:
the ring has a width of 3 millimeters to 12 millimeters,
wherein, the ring has a thickness of 0.1 millimeters to 4 millimeters,
wherein, the ring comprises a fiber-containing braid,
wherein the ring comprises, cardboard and/or a fiber-containing cord, wherein the ring comprises, a biodegradable and/or recyclable material,
wherein, a seal is arranged on the closure body, wherein the seal comprises a biodegradable material, wherein, the seal comprises silicone rubber or silicone, wherein, the seal is arranged so as to be fixed, but mechanically releasable, on the closure body,
wherein, a first connecting region of the bracket and the ring allows a first relative movement from the bracket to the ring,
wherein, a second connecting region of the bracket and the closure body allows a second relative movement between the bracket and the closure body,
wherein, the hinged closure further comprises a movement-limiting guide for the bracket, wherein, the guide can be arranged on the neck region or on a shoulder region of the container body comprising fibers.

16. Hinged closure comprising fibers according to claim 15, wherein the bracket is rigid, wherein, the first connecting region and/or the second connecting region is designed as a cotter pin or comprises a movement groove.

17. The hinged closure comprising fibers claim 15, wherein the bracket is formed in two parts with a joint between a first bracket and a second bracket part.

18. Container comprising fibers according to claim 6, wherein the seal comprises a biodegradable material including rubber and/or polyhydroxyalkanoates.

19. Container comprising fibers according to claim 18, wherein, the seal comprises silicone rubber or silicone, and wherein, the seal is arranged so as to be fixed, but mechanically releasable, on the closure body.
